(19) United States
(12) Patent Application Publication
(10) Pub. No.: US 2010/0299222 A1
(43) Pub. Date: Nov. 25, 2010

(54) ONLINE PURCHASING METHOD

(76) Inventors: George B. Hamilton, IV, Laredo, TX (US); Jennifer G. Hamilton, Laredo, TX (US)

Correspondence Address: STITES & HARBISON PLLC, 1199 NORTH FAIRFAX STREET, SUITE 900, ALEXANDRIA, VA, 22314, US

(21) Appl. No.: 12/787,760

(22) Filed: May 26, 2010

Related U.S. Application Data
(63) Continuation-in-part of application No. 11/507,022, filed on Aug. 21, 2006.
(60) Provisional application No. 60/709,970, filed on Aug. 19, 2005.
(60) Provisional application No. 61/292,919, filed on Jan. 7, 2010.

(51) Int. Cl. G06Q 30/00

(52) U.S. Cl. 705/26.1

(57) ABSTRACT

A method and system is provided for managing multiple, simultaneous, multi-parameter negotiations for the purchase of products or services, such as agriculture products in an Online private contract environment. In the various embodiments, the method comprises a process to compile a database consisting of value-relevant product attributes and buyer demand attributes; a protocol to search, sort and display products and demand for products based upon these attributes; a protocol to aggregate products into “pooled” lots for sale; a protocol to allow sellers to negotiate simultaneously with multiple potential buyers on a private contract basis; a protocol to allow sellers to retain partial ownership in the products; and a protocol to produce a financial reconciliation upon delivery of the products or services.

### CROSS REFERENCE TO RELATED APPLICATIONS

This application is a continuation-in-part of U.S. patent application Ser. No. 11/507,022, filed Aug. 21, 2006 which claims priority to U.S. Provisional Application No. 60/709,970, filed Aug. 19, 2005 and this application further claims priority to U.S. Provisional Application No. 61/292,919, filed Jan. 15, 2010, all herein incorporated by reference.

### FIELD OF THE INVENTION

The present invention relates to a method and system for conducting an online market for buying and selling products and services and in particular, a method and system for buying and selling products and services between buyers and sellers which allow simultaneous multi-parameter negotiations between buyers and sellers on a private contract basis.

### BACKGROUND OF THE INVENTION

Online platforms for the trading of goods and services are becoming increasingly popular. These platforms may take the form of auctions, reverse auctions, and catalog sales. In auctions and reverse auctions, the winner is designated as that party who has bid the highest (or lowest in the case of reverse auctions) when the time for the auction has concluded. In catalog sales, the buyer purchases at the published price. In a “private contract sale”, a buyer and a seller have the ability to negotiate with whomever they choose, set the terms and conditions of the transaction, and conclude a transaction when there is agreement on these terms and conditions. However, these private parties are typically negotiating without knowledge as to their competitive options.

The sale and marketing of agricultural goods and services have used similar methods to conduct business over the past hundred years. For example, the above-described method has been used for the sale of cattle as one agricultural product. Consistent with the described general market, over the years, a number of different marketing techniques for cattle have been used. These include annual feeder cattle sales, local auction yards, and private treaty transactions between producers and order buyers. Auctions are widely used as a means of establishing livestock prices through competitive bidding among potential buyers. However, competition among buyers at many local auction markets, in terms of buyer numbers, has declined in recent years. The costs associated with maintaining a force of buyer representatives to travel from auction to auction are high. Additionally, the number and selection of specific types of livestock at many local auctions has declined as sellers have found alternative marketing outlets. As a result, buyer interest at some local auctions has declined. This means fewer buyers now compete for the available livestock at some auctions, and this ultimately may impact prices negatively.

Used throughout this disclosure the term “seller” is used to collectively refer to a producer, be it a person or group who sells a product, goods, or service, which includes but is not limited to a seller, seller agent, producer, and a producer agent, collectively referred to as a “seller”. In the livestock market, sellers lack the time, resources or skills to fully test the market. Their market is generally confined to the local area, through the auction barn or in deals with order buyers who represent the feedlots/packers. Information about the herd management practices of the producers is limited, inconsistent, and poorly documented. Buyers which include, but are not limited to buyers and buyer agents, and order buyer (collectively referred to as “buyers” throughout this disclosure) exploit this information gap to their advantage, transferring the transactional risk to producers in the form of lower prices.

The average-sized cow/calf operator in the United States has an inventory of less than 50 cows. Therefore, many sellers do not have the option of putting together “load lots” or large inventories to fill orders from a buyer. The optimum lot size for cattle is between 200-250 head. Currently individual producers are unable to tap into this market effectively. Thus without effective pooling of cattle producers of small lots will not be able to improve the net market value of their cattle.

To reach more buyers, a seller must market its cattle more effectively. However, a seller's cost of marketing cattle can be high. If one accounts for the total marketing costs, including trucking to auction yards, shrink and commissions, the costs can range from 8-12 percent of the value of the animals. These costs are even higher in areas isolated from the major feeding centers.

Sellers traditionally have four outlets for selling their cattle: (1) private treaty (30%), (2) auction (30%), (3) video auction (4%), or (4) contract through another means (36%). While each of these methods had pro's and con's, the seller was found to value the following:
Fair pricing,
Upfront pricing that can be accepted or rejected,
Convenience of sale,
Large buyer base looking at their cattle,
Low stress and shrinkage, and
Ability to differentiate based on history and reputation of the producer.

None of the aforementioned four existing current methods of sale meet all producer's criteria. Its overriding concern is that they lack the time, resources and expertise to expose their cattle to the marketplace. Private treaty is seen as the best current method to receive fair pricing, but is limited by the seller's ability to reach a competitive buyer pool.

Buyers fall into one of three categories:

(1) Feedlot Buyers—These buyers work full time for large feeding operations like Continental Grain. These buyers may individually purchase 100,000+ cattle per month. They buy direct from large producers and use a network of order buyers to fill their needs. An order buyer is a buyer or buyer agent who is paid to find and buy cattle. The order buyers prefer to buy from reliable sources of supply that produce consistent carcass grades. This is expensive and large consistent inventories of cattle are hard to find.

(2) Specialty Beef Buyers—These buyers work full time or under contract to companies like Meyer Foods, or Laura's Beef. They fill orders based on clear standards of beef production and carcass quality (organic, angus, prime or choice grading for example).

(3) Independent Order Buyers—These buyers know sellers, e.g. producers, on a regional level and fill orders usually from large feedlots or premium beef buyers. This group has longstanding relationships with both producers and feedlot buyers built on trust.

Buyers typically must maintain a force of buyer representatives e.g. buyer agents, who to travel to auctions, feed yards, and individual producers to gather the inventory of cattle needed for the orders. The costs associated with this buying method are high and restricted to the amount of territory a person can cover. They are also limited to the times and quantities at the local auction barns and grown by those producers within their territory. Typically a buyer can cover 100 mile radius and this limits buying to within that range. This current way of buying is extremely time consuming and very expensive.

Traditionally, the beef industry has exchanged as little information on cattle as possible. Some producers see providing less information as protection against possible litigation from consumers and retailers. With heightened awareness of cattle disease and safe product handling, producers would rather not be identifiable. Feedlots and their buyers use a lack of specific information about a group of cattle to pay as little as possible. Knowing that consistency of beef, regardless of grade, is one of the industry's goals, they offer the producer the lowest possible price based on the breed and mix of the herd. Actual carcass grade, which is the key component of the feedlot value assessment, is rarely provided back to the producer. Many times the cattle are not traceable individually because of the sorting of breed and size when the cattle enter and leave the feed yard. The packer tends to grade by lot and provide the average grade price back to the feedlot. The packer uses this lack of information to their advantage, giving the feedlot average prices by grade groupings, rather than specific carcass grades which are traceable to a particular animal.

The result of this information deficit is a lack of trust and further hold-back of information. As traceability becomes mandated and accurate information becomes a natural part of the transaction, cattle production will have to become an information-based business.

In the end, producers produce what they know, what their land and geography will support, and what they perceive the market wants. This perception of the market is generally colored by the order buyers with whom they regularly interact, not by regional market forces.

### SUMMARY OF THE INVENTION

The present method and system is a completely novel way to buy and sell goods and services by sellers, e.g. providing sellers, a marketing process that more fully exploits their management practices to an increasingly selective buyer core. Further, the present method, in one specific advantageous form, allows for two or more sellers to negotiate in an online environment to pool their respective inventories for the goods or services to be sold. This pooled seller lot can then be purchased by a buyer or group of buyers. As a result of pooling the sellers' inventory, the pooled sellers can attract bigger buyers and attract larger food companies who are interested in purchasing relatively large lots.

In addition, the present method and system allows for a more diverse buyer pool to enter the market not limited by geographical constraints previously hindering existing markets. In addition, buyers may pool their demand to allow groups of buyers to collectively purchase goods and services from one or more sellers thereby realizing a volume discount by purchasing in bulk from one or more sellers. In addition, pooling buyer demands now allows previous buyers unable to purchase complete lots from a seller, to now purchase a portion of the seller's lot by joining up with other buyers interested in the same goods or services.

When the present method and system is implemented in the cattle market, the method and system allows for the leverage of animal identification data by appending that information to a comprehensive information database by the producer, the management practices of the producer and the value-relevant characteristics of the cattle. As previously noted, with regard to the cattle market, value-relevant characteristics may include, but are not limited to diet, weight, age, sex, ship date, delivery date and grade/quality. In accordance with one form of the present method and system, this information will be available to the buyer through a central database such as an Internet accessible web-based database.

In use, the present method and system allows a producer or a producer agent, collectively referred to as a seller, and a buyer or buyer agent, collectively referred to as a buyer, to interact in an online virtual market. The online environment is advantageously implemented so that the seller, e.g. a producer, can communicate with a seller agent, e.g. a producer agent and a buyer can communicate with a buyer agent through the implemented system.

Advantageously, a producer agent will work with producers to position their cattle to their best advantage. The producer agent will profile the producer's management practices and gathers information about the herd. The present method and system can then leverage this animal identification data by appending to it comprehensive information about the producer, its management practices, and the value-relevant characteristics of the cattle. The producer agent can use the method and system to be an advocate for the producer and expose the producer's management practices and product to the most interested buyer pool, regardless of location. This information can then be disclosed to the buyer community through a web-based interface that matches one or more seller's inventory with one or more buyer order profiles.

Preferably buyer agents work with buyers to understand and profile their requirements, develop a forward-looking profile of their requirements, assist them in sourcing cattle, execute purchases pursuant to agreed parameters, and facilitate the sale using the following system and methods. This profile is matched by the present method and system with appropriate inventory and the method and system facilitates private negotiations for the sale.

In one advantageous form, the purchased cattle remains at the producers location until the buyer takes delivery by picking up the cattle in trucks. Thus the buyer takes ownership when the cattle enter the truck. The producer dose not have to transport its cattle to an auction or feedlot to sell its cattle. Advantageously, this is facilitated by administration during post-sale activities.

After the sale is complete, the method and system generates invoices and transaction reports. Advantageously, in one form, the present method and system gathers critical data which is stored. This data is gathered by the system and used by the agents and administration to analyze and track market data and value drivers within the cattle attributes.

The present method and system invention is a comprehensive online transaction management environment. In one exemplary embodiment, buyers and sellers must register and be approved by a host according to prevailing credit policies. Once approved, the parties are granted log-in privileges. Upon log-in, the party is directed to his or her unique homepage where he or she is given access to his or her transaction control panel and other tools. The transaction control panel is his or her “dashboard” and enables the user to search for products or demand for products, view summary and detailed information regarding their pending negotiations, enter offers/counteroffers on transactions, and view the history of closed transactions. Actions by other users calling for a response (counteroffer, rejection, or acceptance) from the user are prominently displayed to enable the user to manage its negotiations.

In the virtual market, in accordance with this embodiment, a seller characterizes its product/service relative to value-relevant attributes. A buyer likewise characterizes its requirements according to these attributes. These characterizations are compiled by the present system into lot profiles and order profiles respectively. The lot profile is a product “listing” describing the product and the terms upon which it is being offered for sale.

Sellers may search the database of order profiles to ascertain the “demand” for their product/service and view results ranked upon the extent to which the demand corresponds to the specific attributes of the seller's product. Likewise, the buyer may search lot profiles to ascertain the “availability” of products that meet their requirements ranked upon the extent to which the available lots correspond to the order profile. Sellers and buyers may thereafter elect to enter simultaneous negotiations with an unlimited number of parties to sell or buy the product.

The present method and system provides a transaction management toolset to enable the transaction intermediary, or host, to provide value-added involvement of agents to assist the parties in the process or permit the buyers and sellers to interact directly through the online environment without the aid of agents.

In a further specific embodiment, the present method and system provides a means to aggregate like-in-kind products into lots comprising a full “load” for purposes of realizing economies of transportation and distribution and to provide a means for small producers to participate in larger markets.

In accordance with another aspect of one form of the present system and method, the seller and buyer negotiate based upon price and retained ownership. In a retained ownership transaction, the seller retains an undivided interest in the sold products as a means to hedge his price position. Thus, a seller may accept a lower price with a higher retained ownership if he believes the price of the product is likely to go up in the near term.

In accordance with yet another aspect of one form of the present system and method, sellers are able to “put” an offer to a buyer, and buyers can make on offer to a seller. Once made, the offer posts to the other party's control panel and that party is alerted by email of the pending offer. Offers may be made to expire at specified dates and times, or will expire, if not accepted, when the listing for the product expires. Buyers and sellers may negotiate simultaneously with any number of parties. Offers not expressly accepted are deemed rejected.

In accordance with one form of the present system and method, the negotiation process continues until an offer/counter offer is “accepted” by a party, at which time a contract is formed.

The present system and method provides a means to coordinate product delivery, reconcile the “listed” products to the “delivered” products, and produce a financial statement including computed fees, commissions and expenses of the host/intermediary.

The present system and method captures transaction specific data regarding the attributes of the sold products and the price at which they sold. This data, on an historical basis, enables the host and users to adapt their product and procurement strategies to how the market is valuing the attributes of the product.

The present invention in one form thereof relates to a method for managing simultaneous multi-parameter negotiations for the purchase of goods or services in an online private contract environment. The method includes accepting a demand request from a buyer using a computer network in an online environment. The demand request consists of a product or service with associated value relevant product attributes and buyer quantity demand. An online accessible database is compiled consisting of the buyer demand request with the associated value-relevant product attribute and the buyer quantity demand. Multiple sellers access the online database to negotiate simultaneously with the buyer on a private contract basis in order to satisfy the buyer's request.

In one specific form, the present method further comprises finalizing a contract between the buyer and one or more sellers thereby completely satisfying the buyer's request. Advantageously, the buyer's request is satisfied by forming at least two contracts, one contract between the buyer and each of at least two sellers, respectively.

The present method may be implemented in which the products comprise livestock and the associated value-relevant product attributes are one or more selected from the group consisting of diet, weight, age, sex, ship date, delivery date and grade/quality. In one advantageous implementation, a seller produces the products or services after reviewing the buyer's demand request.

The present invention in another form thereof relates to a method for managing simultaneous multi-parameter negotiations for the sale of a product or service in an online private contract environment. The method comprises permitting a seller to list a product or service to be sold, using a computer network in an online environment. The product and service comprise associated value-relevant product attributes and quantity of the product or service to be sold. An online accessible database is compiled consisting of the product or service with the associated value-relevant product attributes and quantity. Multiple buyers access the online database to negotiate simultaneously with the seller on a product contract basis in order to satisfy the multiple buyers' needs.

In one advantageous form, multiple buyers combine their respective demand requests to form a pooled lot comprising the product or services and associated value-relevant product attributes and a combined desired quantity of the product or services. The multiple buyers negotiate with the seller for purchasing the pooled lot from the seller.

In another advantageous form, multiple sellers can combine their respective inventories to form a pooled seller lot comprising the products or services and associated value-relevant product attributes. One or possibly a group of buyers can purchase the pooled seller lot, thereby allowing the pooled sellers to attract bigger buyers and attract food companies directly to get a better price.

### BRIEF DESCRIPTION OF THE FIGURES

FIG. 1 is a diagram which illustrates a general flowchart for purchasing and selling goods and services in accordance with one form of the present invention.

FIG. 2 is a diagram illustrating registering participants in a market in accordance with the present invention.

FIG. 3 depicts a collection of product attributes, namely cattle attributes and storage of the information in accordance with the present invention.

FIG. 4 is a diagram showing presale management in accordance with the present invention.

FIG. 5 is a diagram showing a relationship between participants in a market in accordance with the present method and system.

FIG. 6 is a diagram which illustrates activities available to a buyer and buyer agent in accordance with the present invention.

FIG. 7 is a diagram illustrating the buyer/buyer agent creation of a profile in accordance with the present invention.

FIG. 8 is a diagram illustrating a buyer/buyer agent method for creating an order without previously creating a prior profile in accordance with the present invention.

FIG. 9 is a diagram illustrating a method for a buyer/buyer agent to select an existing order in accordance with the present invention.

FIG. 10 is a diagram illustrating activities available to a seller/seller agent in accordance with the present invention.

FIG. 11 is a diagram illustrating a method for a seller to list inventory on the system as a presale lot, presale pooled lot and lot in accordance with the present invention.

FIG. 12 is a diagram illustrating the creation of a presale lot in accordance with the present invention.

FIG. 13 is a diagram illustrating the creation of a presale lot in accordance with another aspect of the present invention.

FIG. 14 is an illustration of the creation of presale pooled lot in accordance with the present invention.

FIG. 15 is a diagram illustrating activities, reports and search capabilities of an administrator and/or a super user in accordance with the present invention.

### DETAILED DESCRIPTION OF THE PREFERRED EMBODIMENTS

The present invention is directed to a method and system which enables buyers and sellers to conduct simultaneous, one-on-one negotiations for the sale or purchase of agriculture products/services in a market informed context.

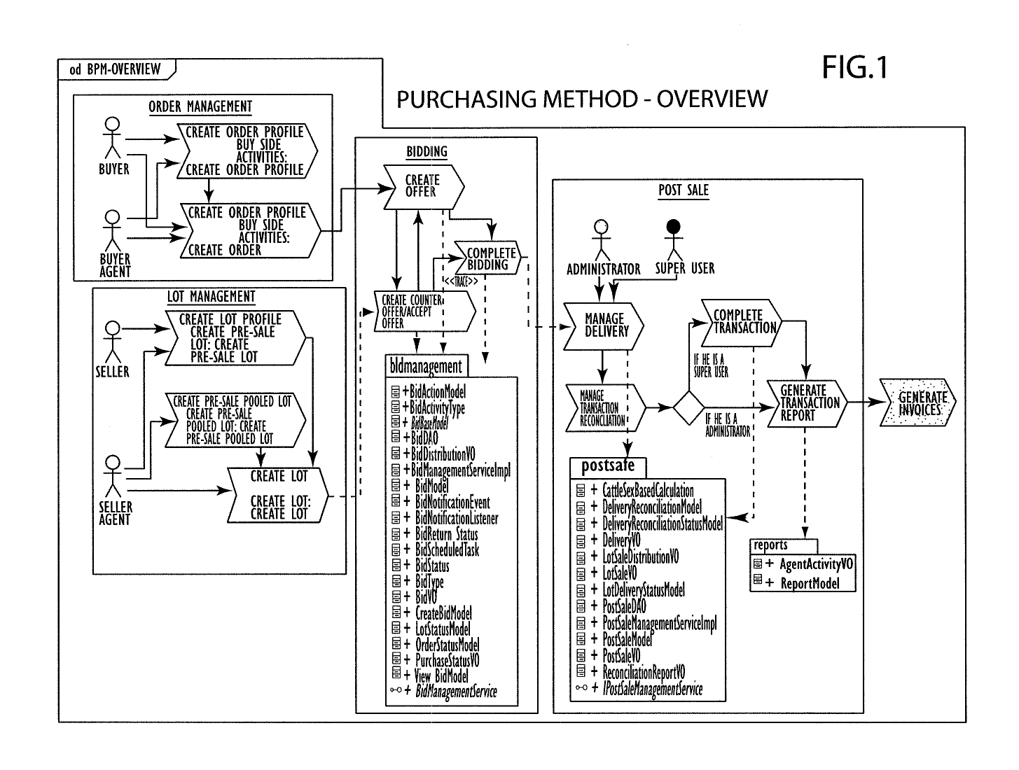

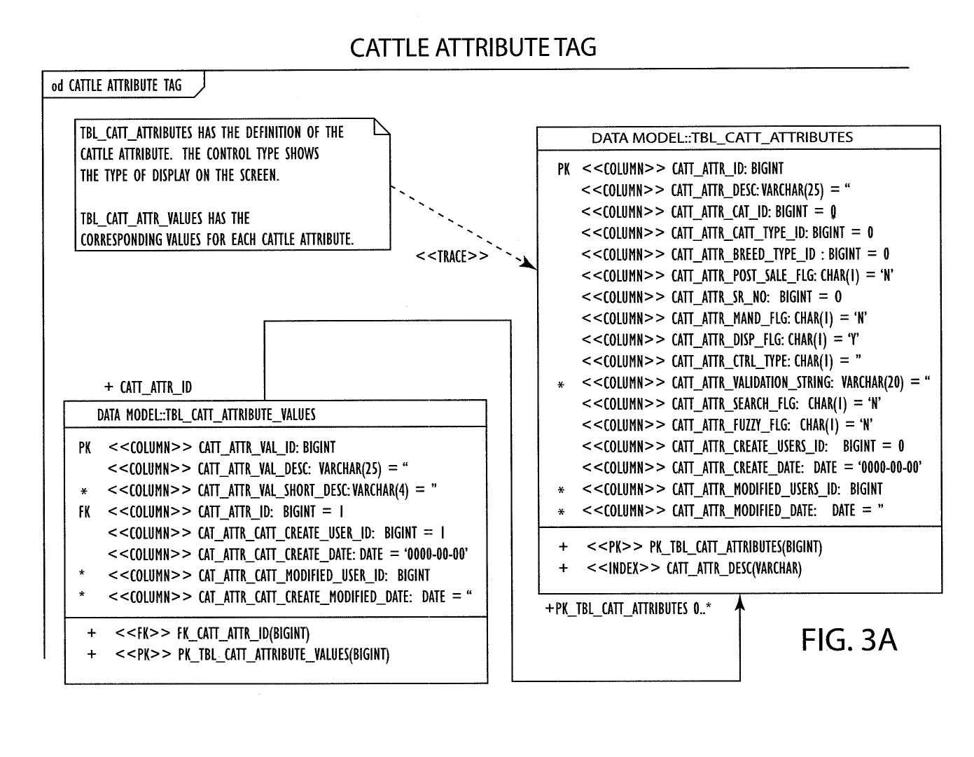

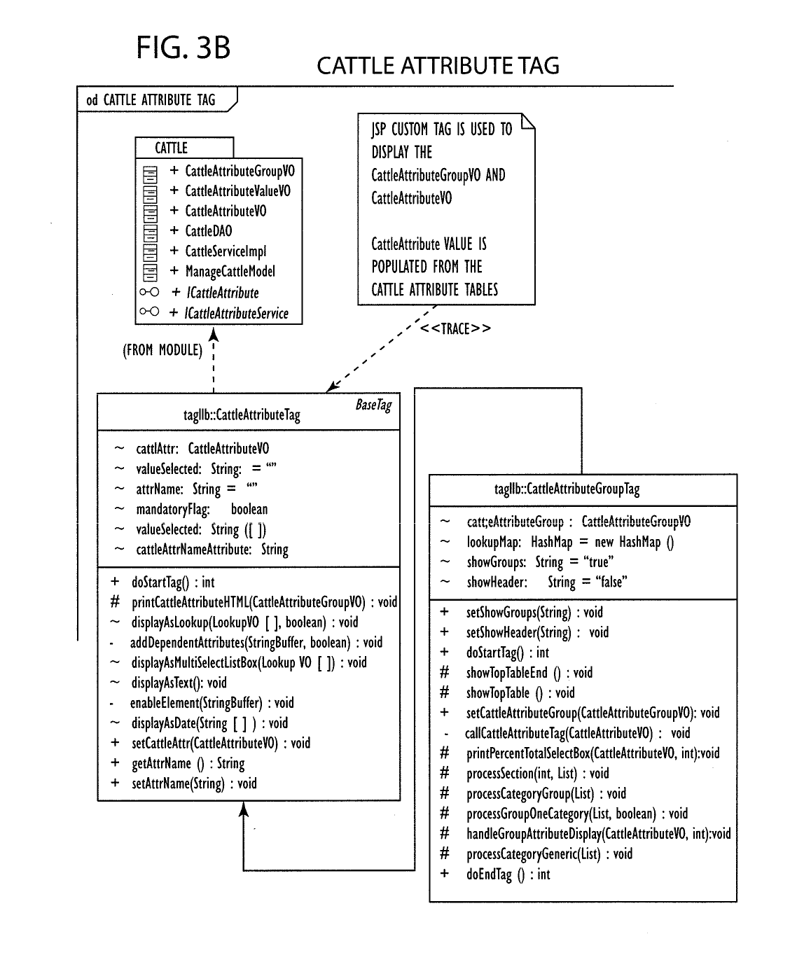

The present method and system is described with reference to specific embodiments shown in FIGS. 1-15.

Referring now specifically to FIG. 1, the depicted flowchart illustrates a general implementation of the present method and system for buying and selling goods and services such as agricultural products and services. FIG. 1 shows order management as it pertains to the buyer listing wanted inventory and creating an order for the inventory needed. Advantageously, the present method and system is implemented in an online environment, as understood by one of ordinary skill in the art. Accordingly, the online environment consists of one or more servers and client computers have respective processors, computer memory, data storage, and the like, in order to implement the present method and system as described herein, which will be apparent to one of ordinary skill in the art.

FIG. 1 also shows Lot Management as it pertains to the seller, e.g. a producer of the inventory. The Lot Management allows the producer to list information specific to its inventory, management of the inventory, information important to the sale of the inventory, availability of products for pooling inventory with other producers, and any information that will market their inventory in a beneficial way. Several profiles of different inventories may be made and saved in the present method and system during this point of the Lot Management. After these profiles are created and saved, a producer can list the inventory for sale using a saved profile or create a new profile. This is called “Create Lot”.

After a lot is created and a buyer has created an offer, the present method and system proceeds to the second phase, referred to as “bidding”.

During the bidding process, offers from the buyers are reviewed by the producer and an agent for the producer. Producers can accept an offer, counter offer, and or reject an offer. If the producer rejects all offers, all bidding ends. If the producer counter offers, the revised bid and its current demands are then sent to buyers and they can review and accept or reject the counter offer. The offer and counter offer process will continue until an offer is accepted or all offers are rejected. If the producer accepts an offer, the bidding stops and the process moves into a post-sale process.

Information of delivery of the inventory, transfer of funds and reconciliation and then managed. Also at this time, information about the inventory is gathered, which includes, but not limited, to price, quantity, weight, location, pooled/not pooled, vaccinated, management practices unique to that producer.

After confirmation of the delivery is made by the buyer's agent, then the transaction is complete and reports are generated and the invoices are generated.

Registration as Buyer, Producer and/or Guest

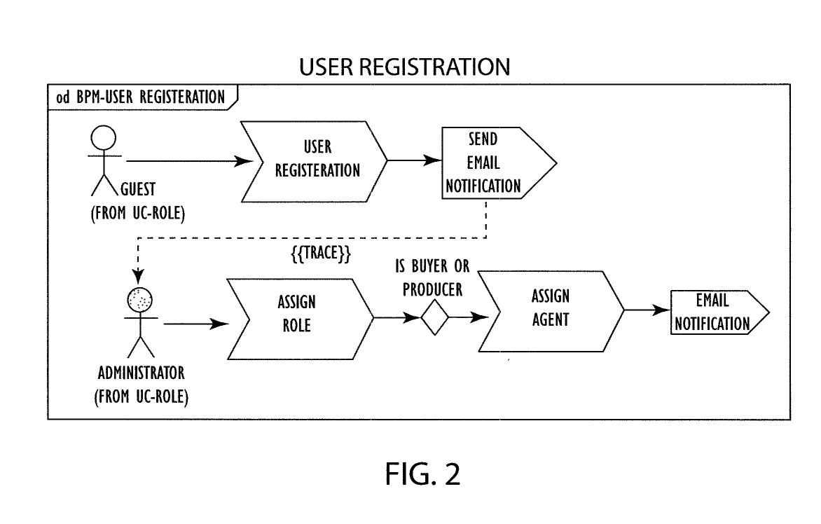

Referring now to FIG. 2 along with FIG. 1, FIG. 2 illustrates user registration. During registration, a producer/buyer inputs name, address, contact information, bank account information, all the traits of the cattle, and all the management practices of the producer, e.g. a ranch. An initial first step is for a new party to first register as a “guest”. Subsequent to guest registration an administrator is notified, e.g. by email, with the guest information. The administrator approves the guest to become a user after verifying the guest's inputted information; and assigns a role to the guest as either producer or buyer. In certain instances, which will become apparent from this full disclosure, some guests may be both buyers and producers. Then the administrator assigns a producer or buyer agent (as appropriate) to the guest. An email is sent to the guest containing login information and producer/buyer agent information. After this initial process, the guest becomes a user, and an email is sent to notify the agent of his assigned user.

Order Management

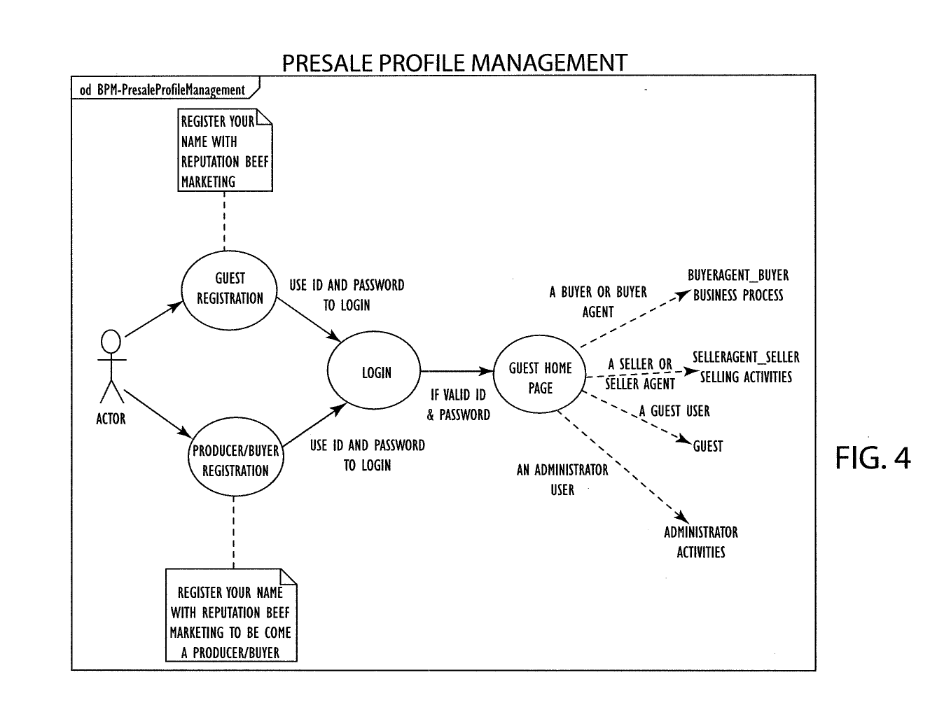

After a participant/user has registered and assigned a role, e.g. a guest, a producer or buyer, the participant logs into the present system and is directed to a specific homepage of the assigned role of guest, buyer, seller/producer, and/or administrator, as illustrated in the Order Management of FIG. 4.

Buyer agents who are assigned by the administrator will work with buyers to understand and profile the buyers' requirements, assist them in sourcing cattle, execute purchases pursuant to agreed parameters, and facilitate the sale. Using the Order Management, a buyer or buyer agent will create order profiles of the needed cattle inventory. The order profiles will include the cattle attributes and develop a forward-looking profile of his or her requirements. Several order profiles can be created a buyer/buyer agent. The order profile will show producers what the buyer is wanting to buy and the specifications that are desired. This allows a producer to produce a future product of cattle that meets these specifications.

A buyer or buyer agent will then create an order. An order is created when the order profile(s) of the buyer's needs are entered into the present system, named, and saved. Then the buyer/buyer agent will select the option to create an order. The buyer/buyer agent can create this order using a pre-created profile or he or she can input new attributes that are wanted for a current order and then select “Create Order”. The Order is then listed on the system for Producer and Producer agents to review. The order profile will be matched by the present system and inventory listed and also by agents of the system. Matches may include the inventory currently listed on the system, future inventory that is not listed yet, and/or cattle not within our system the is located in the territory or geographic location of the producer agent.

Order matching is accomplished by the producer agent knowing the market in which he or she works and can ask non-registered producers to meet the need of the buyer by selling their cattle on the system. When an order profile is matched by the present system with appropriate inventory and the system notifies the producers and buyers of the proposed match. As a buyer, one can search inventory listed within the present system based on listed qualities such as, but not limited to quantity, weight, date available, retained ownership, pooled/non-pooled, location/distance, breed, sex and so forth. This is done by showing a list of the matches within their personal accounts held and managed within the system. When the buyer/buyer agent finds the needed inventory, the buyer/buyer agent will be able to make an offer. When an offer is made, the buyer/agent progresses into a bidding process. The system will utilize these profiles to continuously locate, rank and rate available inventory and facilitate a private treaty negotiation for each herd. A “buyer-centric”, web-enabled system enables the buyers to manage their inventory pipeline and helps ensure the reliability of their supply chain.

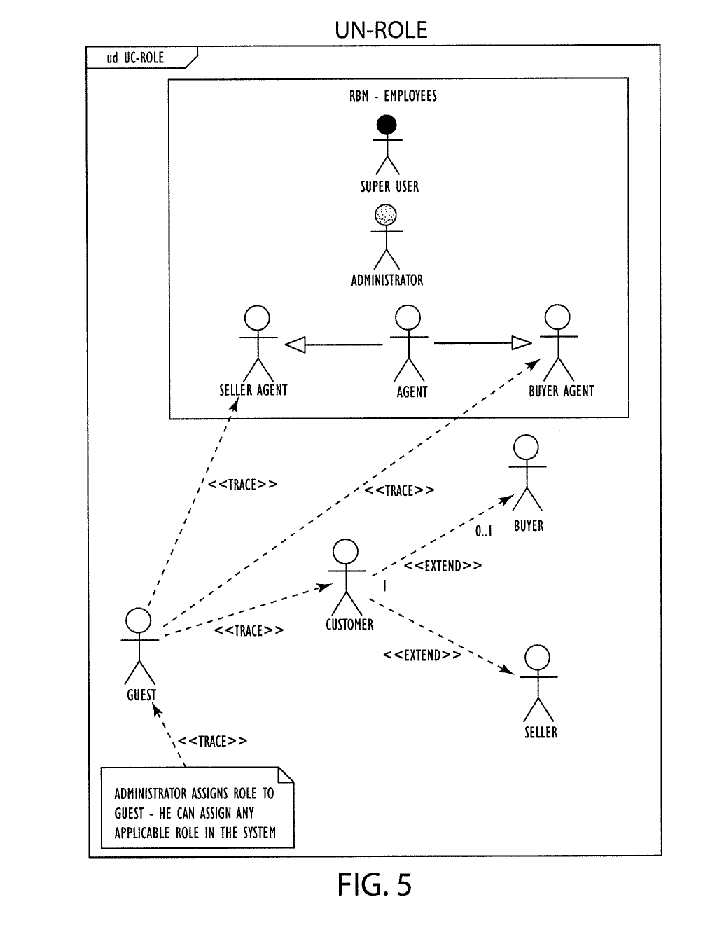

In one specific further embodiment, FIG. 5 illustrates interaction between the participants and company agents in the present system. A “super user”, administrator and agents are company employees. Guest registers and then the administrator assigns a buyer and/or seller agent to the guest. Then the guest becomes a consumer, i.e., either a buyer and/or a seller. A customer may be both.

A super user is an executive, such as a CEO, CFO or owner of a company, using the present system. As a super user, one can monitor and access all transactions, system codes, gather attributes from sales and inventory, review and post financials for the company, and review all producer and buyer information. Further, the super user is able to monitor the administrators and give directions, as appropriate.

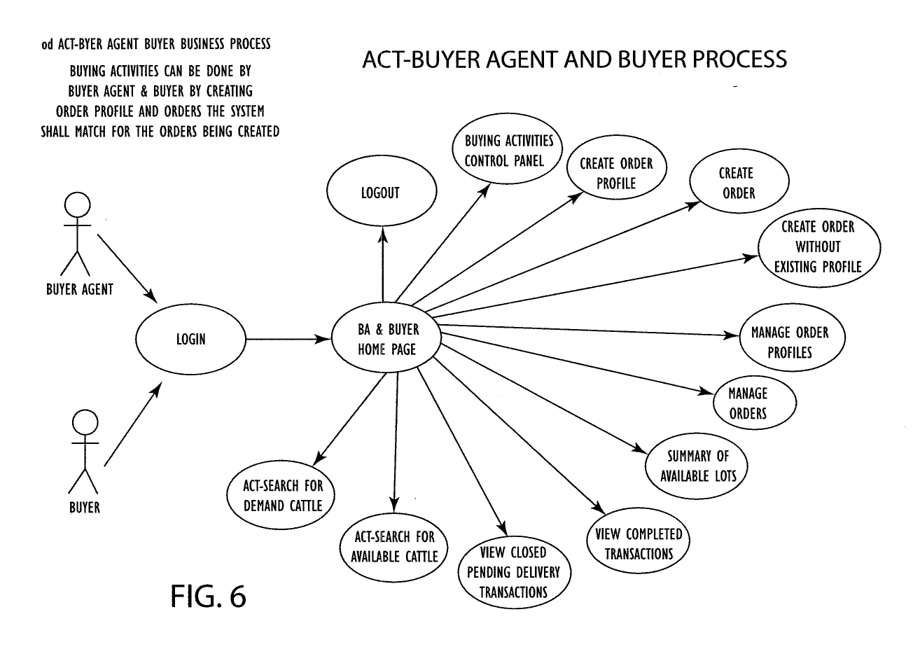

Various possible activities to which the present system can be adapted include but are not limited to activities shown in FIG. 6. Using the present system, a buyer agent can view open orders, and respective status, open orders by order end date, order profiles created by the buyer/buyer agent, view closed pending delivery orders and completed transactions. The present system can list orders placed by either buyers or their buyer agents and list details on those orders such as total need and filled inventory. The need and filled inventory advantageously can be represented by percentages. Buyer agents advantageously can view orders, buyer/view profile, and view details on orders placed in the present system. Buyer agents can also advantageously view order status, closed percentages, offers and availability of lots for bidding as well as view bidding details of each order.

Bidding

A buyer/buyer agent selects inventory and creates an offer. The offer is sent to the producer/producer agent through the system communication network (e.g. computer network) and is viewable in the producer/producer agents personal accounts held and managed on the system. The producer agent also calls the producer to discuss the offer and decide to accept, reject or create counter offer. The producer/producer agent accesses his or her account on the system and reviews the multiple offers made for the listed inventory. A producer/producer agent also reviews all notes or comments contained within the listed offers. These notes or comments may include multiple parameters such as shipping allowances, special reserves on the inventory, ability to retained percentage of ownership, and other information that is relevant to negotiations of the sell. These notes facilitate the multiple parameters of a negotiation and affect the acceptance or rejection of an offer. This is the reason a producer may accept a lower sales price, due to desired incentives negotiated within this process. After the acceptance of an offer the buyer and producer move into a post-sale process.

Possible responses to posted orders include but are not limited to accept, reject and/or to cancel the outstanding order. It should be noted that only the one placing an offer and/or agent thereof can cancel the offer. If the producer has submitted an offer/counteroffer, then the buyer will get an accept/reject option, allowing one to accept if the bid price is comfortable or reject if it is not an acceptable price.

As noted above, a buyer can review inventory currently listed in the present system. If a profile of an order placed by a buyer/buyer agent matches inventory currently listed in the present system, the buyer/buyer agent may select and make an offer which is sent to the producer of the listed inventory.

When referring to placing a specific order, a buyer agent can select an existing order profile and select “create order” and the order will then be placed in the present system to be filled by the current inventory. The buyer agent can view the producer's profiles that includes name, contract information, correspondence, ranch management practices and any other information listed by the producer to market its inventory.

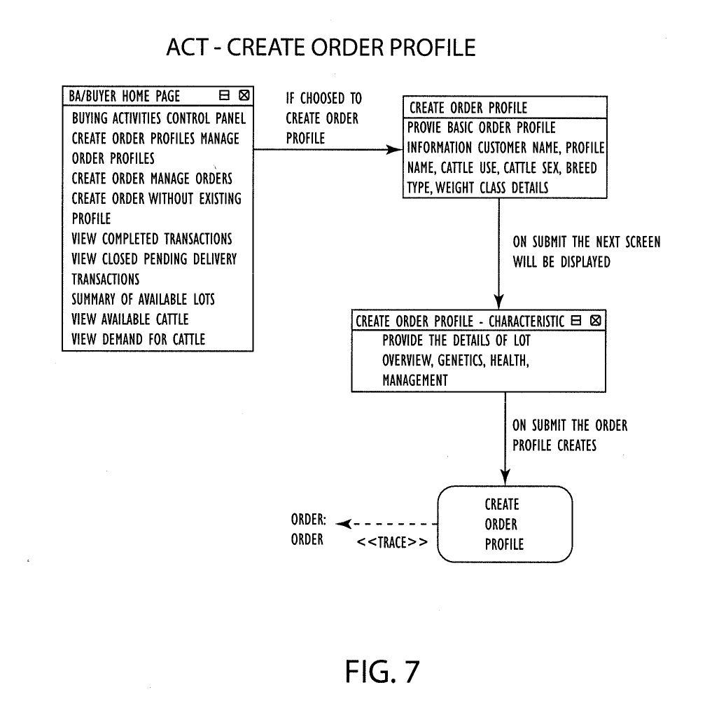

One method by which a buyer/buyer agent creates an order profile is shown in the diagram of FIG. 7. From the buyer/buyer agent interface, the buyer/buyer agent can select “Create Order Profile”, and then input basis profile information of the inventory wanted and by whom, such as customer name, name the profile, quantity, type, breed, sex, and other class details. After inputting the information the buyer/buyer agent can submit the information thereby saving the order profile within the buyer/buyer agent's account in the present system.

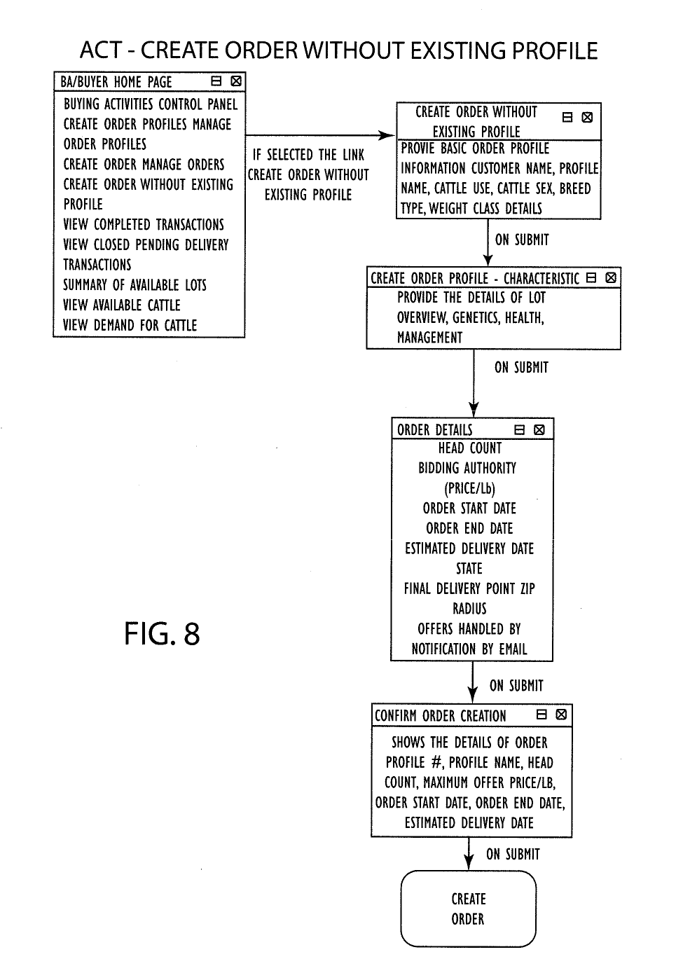

Referring to FIG. 8, an order can be created from a buyer/buyer agent selecting “Create Order” and then selecting from a list of saved order profiles or inputting a new order profile attributes. Then, the buyer/buyer agent can confirm order creation and the orders listed within the present system.

In an alternatively process, an order can be placed without having an existing profile. One implantation of this is shown in FIG. 8 which illustrates a buyer/buyer agent creating an order without having created an existing profile within the present system. The buyer/buyer agent selects this option (“Create Order without existing profile”) and then enters the profile attributes and name and saves the profile to create an order.

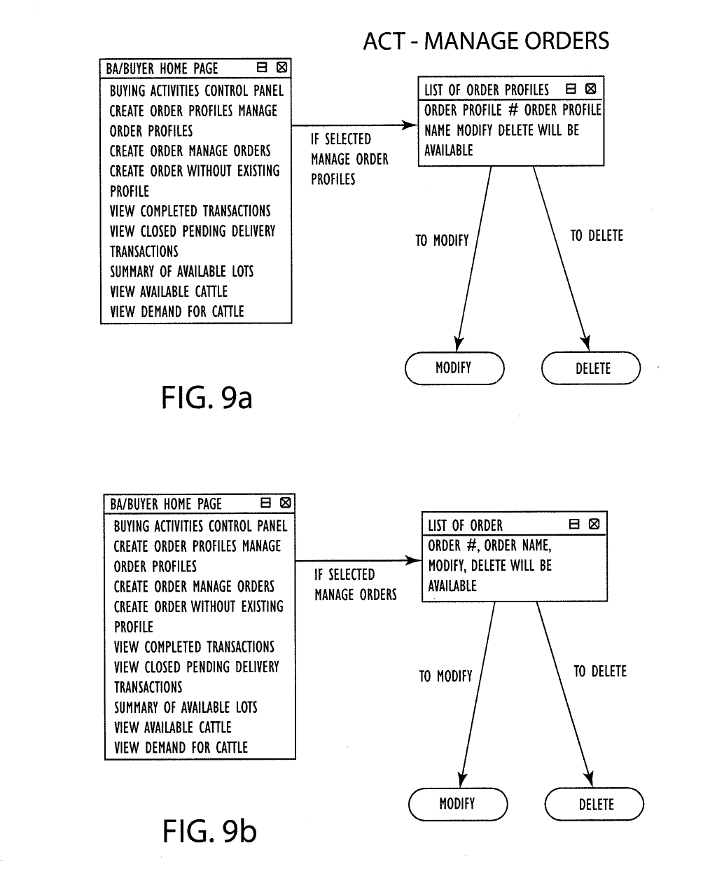

A buyer/buyer agent can modify or delete an existing order profile as shown in the diagram of FIG. 9.

Post Sale

After the acceptance of an offer the delivery of the inventory is managed. The administrator coordinates with the seller agent and buyer agent to provide a seamless delivery of the cattle. The present system allows for the management of the transaction reconciliation in which the buyer provides payment for the purchased inventory. The system receives payment and deducts and the commissions and fees. The buyer receives delivery of the inventory when the inventory is loaded on the truck for shipment. When the inventory is loaded on the trucks, the buyer is approving and taking ownership of the cattle immediately. The funds are issued to the seller.

During this process the system compiles data of the transaction such as: cattle sex, calculation of price based of weight or per head, slide variance, delivery status, days on the market, cattle attributes, and management practices used on those cattle. This information is stored and managed within the system. After the collection of the data, completed delivery, and the transaction reconciled, the system's “Super User” completes the transaction. As previously described, the super user, e.g., CEO, CFO or owner of the company, who is able to monitor and access all transactions, system codes, gather attributes from sales and inventory, review and post financials for the company and review all producer and buyer information. Accordingly, the super user is able to monitor the administrators and give instructions, as appropriate. Then the administrator generates transaction reports such as the agent Activity & the Report model which includes the following:
a) View Completed Transactions
b) View Closed Pending Delivery Transaction
c) Summary of Available Lots
d) Summary of Open Orders and
e) agents Activity Report such as buyer Commission, Seller commission, RBM buyer Share, agent buyer Share, RBM Seller Share, RBM agent, Seller, Lot, Order#, Lot ID, Order ID

After completion of the above, all invoices are printed and mail to all participants in the transaction and the transaction data is compiled, saved and analyzed within the database of the system.

Selling Activities

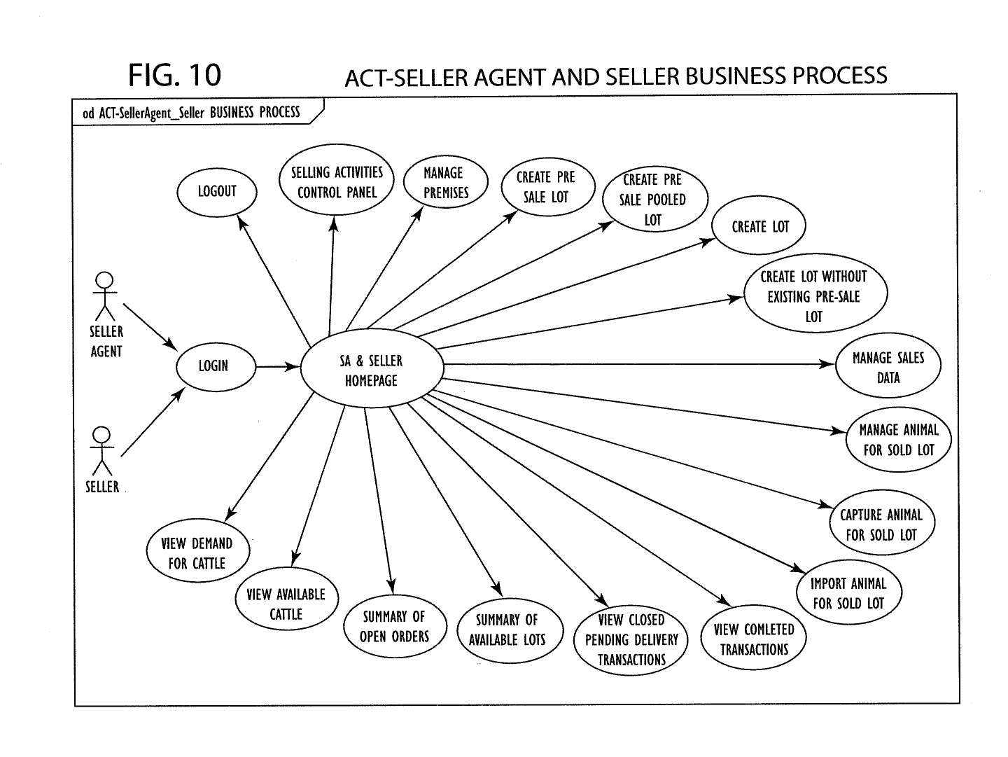

Referring to FIG. 10, a producer or seller registers in the system which includes producer/producer agent may inputting name, address, contact information, bank account information, all the traits of the cattle, and all the management practices of their respective ranch. As with the initial registration of buyers, producers first login as guests. Subsequently, the administrator is notified, e.g. by email with the guest information. The administrator verifies the guest information and then approves the guest to become a user and assigns a role to the guest as a producer. Then the administrator assigns a producer agent to the guest. An email is sent to the guest/producer containing login information and producer agent information. After this process the guest becomes a user. An email is also sent to notify the producer agent of his or her newly assigned user/producer.

The producer agent assigned to the producer helps the producer market cattle. The producer agent will view cattle and verify the cattle traits, type of vaccines they have had and helps list other relevant information to make the cattle more marketable and appealing to buyers. The producer agent makes recommendations to help producers generate cattle that meet the needs of buyers, improve the marketability of the cattle and highlight ranch management practices. The producer with his or her agent set the minimum price he or she will accept for the cattle, duration of the auction, date cattle will be available for pick up, and select a “pooling” option.

Using pooling, producers sell their cattle with other producers to meet the buyers' needs and to have more options for their cattle. Pooling is a process of combining cattle from more than one producer. For example, pooling allows the producer/producer agent the ability to combine cattle with several other producers to make a truck load if he or she does not have enough cattle to make a truck load or fill an order from a buyer. In practice, in using the present system, two or more producers can negotiate in the online environment to combine their respective inventories for the product or service to be sold to form a sellers' pooled lot. The pooled lot can then be offered to a buyer to purchase. Alternatively, two or more buyers can combine resources to purchase the pooled sellers' lot.

A producer list the cattle and their traits that he wants to sell. Accordingly, the producer/producer agent inputs into the present system all the traits of the cattle, ranch management, expected ship date, future sale date of pre sale cattle, and any other information that is important to the sale and marketing of the cattle and ranch management practices. This profile is appended to a National Animal Identification System [NAIS] data record and supports traceability and quality feedback loops. NAIS is a government-run program in the United States intended to extend government animal health surveillance by identifying and tracking specific animals. The data is captured and managed by NAIS, a searchable and sortable system. The present system gathers this “value critical” information regarding the producer's herd management practices and his or her cattle. This information includes management practices, years in the business, financial stability, health information, feed used, historical carcass grades, lineage, castration methods and timing, weaning, implants, etc. The present system analyzes and provides historical data for each producer and buyer thus creating a “stock-like” product for each operation, allowing buyers to buy based on complete profiles compiled by the present system. The profiles of the producers will be branded an and marketed by the present system.

Producers/producer agents can list unborn cattle or pre-sale cattle for sale with an estimated future ship date. This option is used to meet the future demand of orders placed by buyers on the present system. This is much like the trading of future stocks. This method of selling within the present system allows buyers the ability to manage their inventory pipeline.

Producer's cattle is marketed to buyers online and by agents that work for the company. After the cattle are listed, the cattle can be viewed by registered (buyer and sellers) and unregistered users. Producer agents and buyer agents are able to communicate through the system's computer network and/or physically to help sell and buy the cattle. The buyer agents will use the present system's lists of matching order profiles. In addition, the buyer agents can use physically networking, to compliant, online networking, to find additional buyers for the cattle. The listed cattle will be matched by the present system with appropriate demand orders and the system notifies the producers and buyers of the proposed match. This notification of matching inventory is shown by a list of the matches within their respective personal accounts held and managed within the present system. When the buyer/buyer agent finds the needed inventory, the buyer/buyer agent will be able to make an offer to the producer by entering the offer details the present system and creating the offer.

A producer receives offers online in his or her private account within the present system. When a buyer makes an offer, the offer will show up in the producer and producer agent's account and the producer agent will call the producer to review the details of the offer. The producer can also view the offer in his or her account within the present system. The offers and purchased price of cattle will be captured by the system and stored within a database of the present system. This information will be used to help regulate and set the prices for other cattle of similar types listed within the system. This data will be used to create a national exchange system for reference of current minute by minute price of cattle by type, weight regardless of location.

The producer reviews offers and accepts, rejects, or counter offers to the list of buyers. The producer/producer agents will see the multiple offers in his account within the present system. The producer/producer agent selects an offer and views the offer and the details in the notes or comments. The producer/producer agent chooses an option to accept or reject the offer or to counter offer and ask for more money or special provisions within the notes. The counter offer will then be sent to the buyer/buyer agent by the present system's communication network. Then the counter offer will be reviewed by the buyer and he or she will have the option to send an accept/reject or counter offer. The process of accept/reject or counter offer will continue on the present system until all offers are rejected, or an offer is accepted. The producer can accept any offer from any of the buyers that have made an offer.

If several producers are pooling their cattle together, the specification or details of the sale will be listed and agreed upon upfront, before a contract is finalized. The offers from the buyers will be received by all producers/producer agents in the pool and if it meets the listed specifications, they must accept if the offer meets their specified price. However, in one advantageous form, the information of the agreed upon price is not published to the buyers or buyers agents. This allows for multiple offers to be submitted for the pooled cattle and the best offer accepted.

The process for accepting/rejecting or counter offering a pooled lot proceeds as follows. An offer is received by all producers/producer agents in their respective accounts on the system. The offer is not for agreed amount the offer is rejected unless all producers choose the accept option on the system by the offer. If an offer is made above the agreed upon price, accept is mandatory. If multiple offers come in above the agreed upon price, then the producers must unanimously select accept for one offer. This will complete the bidding process on the present system.

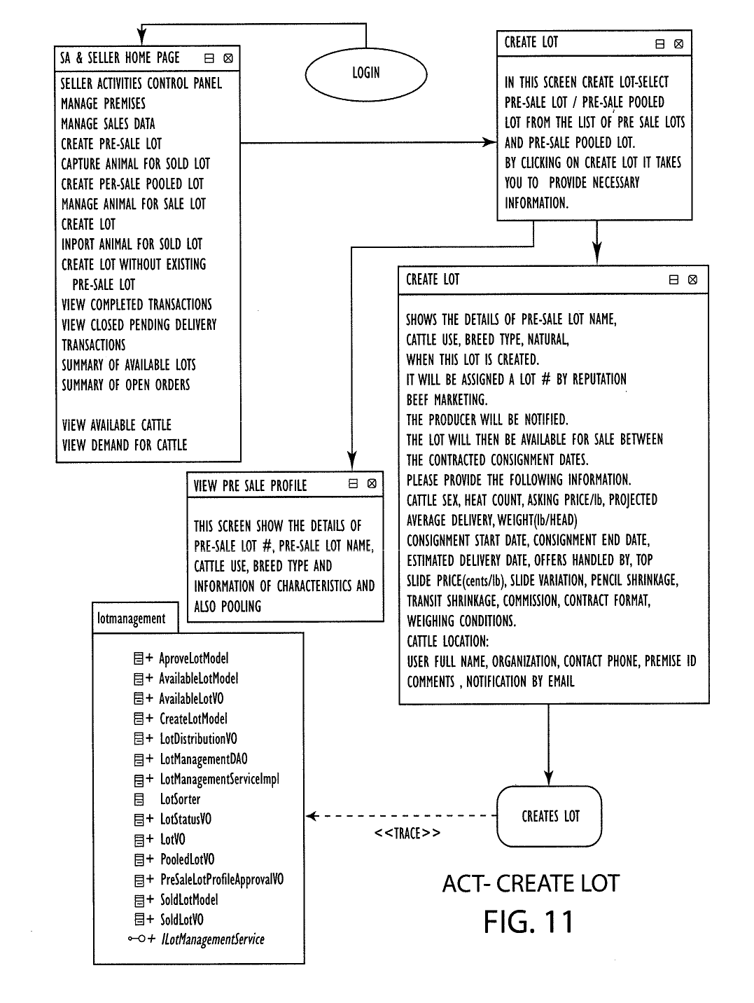

FIG. 11 shows specific embodiments of a method by which sellers can pool lots. As noted above, inventory may be classified by the present system as pre-sale lot, pre-sale pooled lot, and lot. By clicking “Create Lot” the seller/seller agent can input the information about the inventory such as, quantity, weight, type, breed, sex, project average delivery weight per head, consignment start date, shrinkage, slide, condition, location and any other information important to the marketing of the inventory.

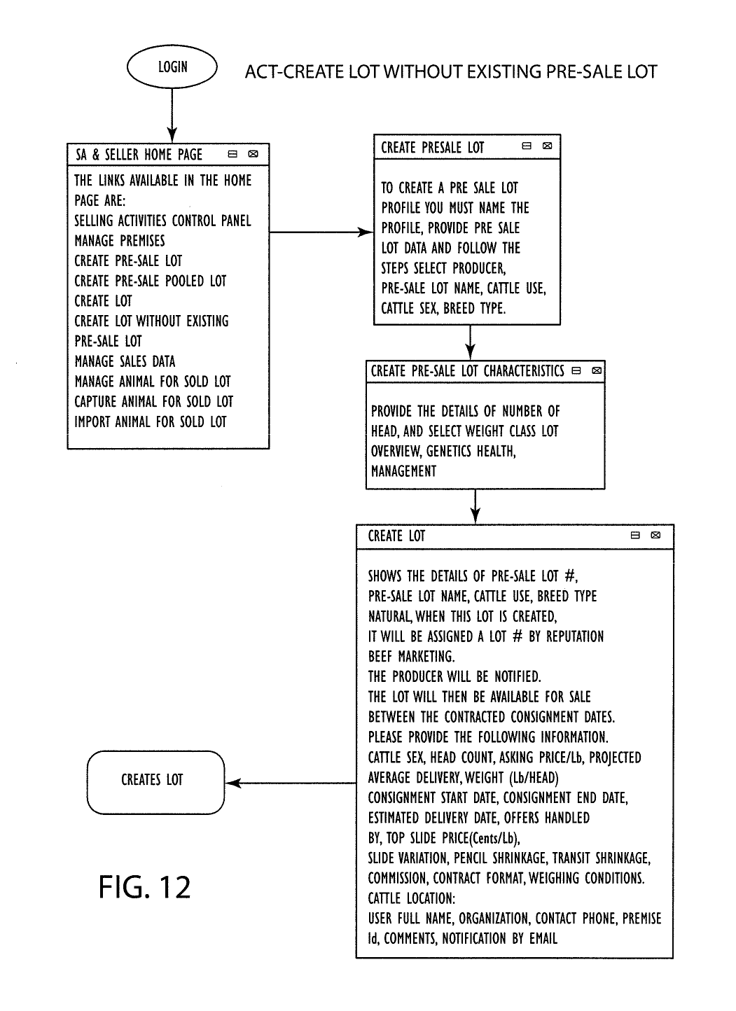

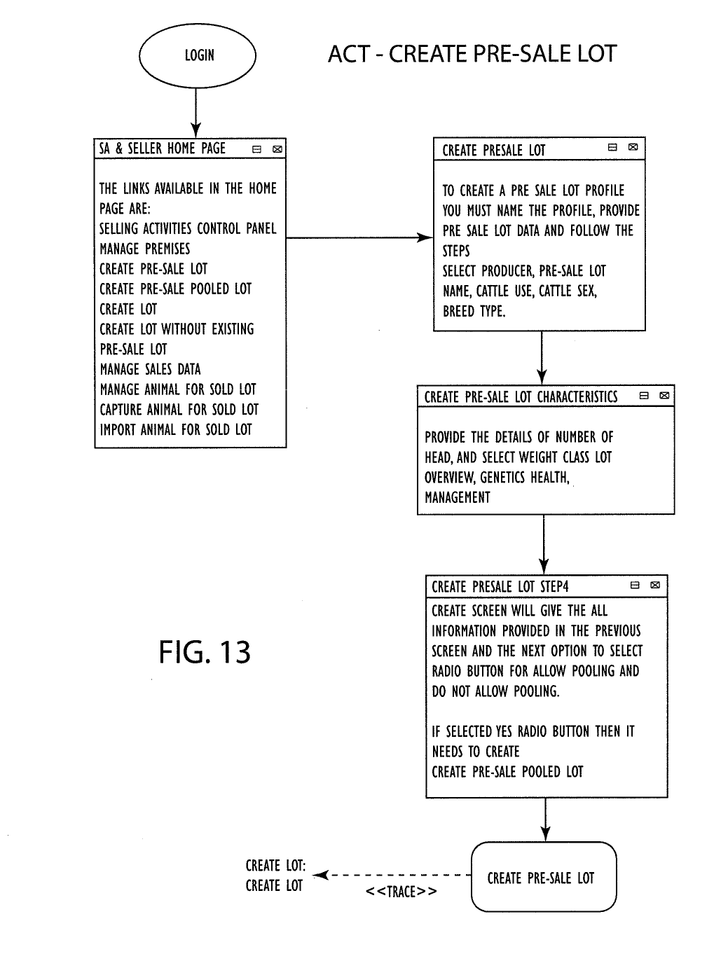

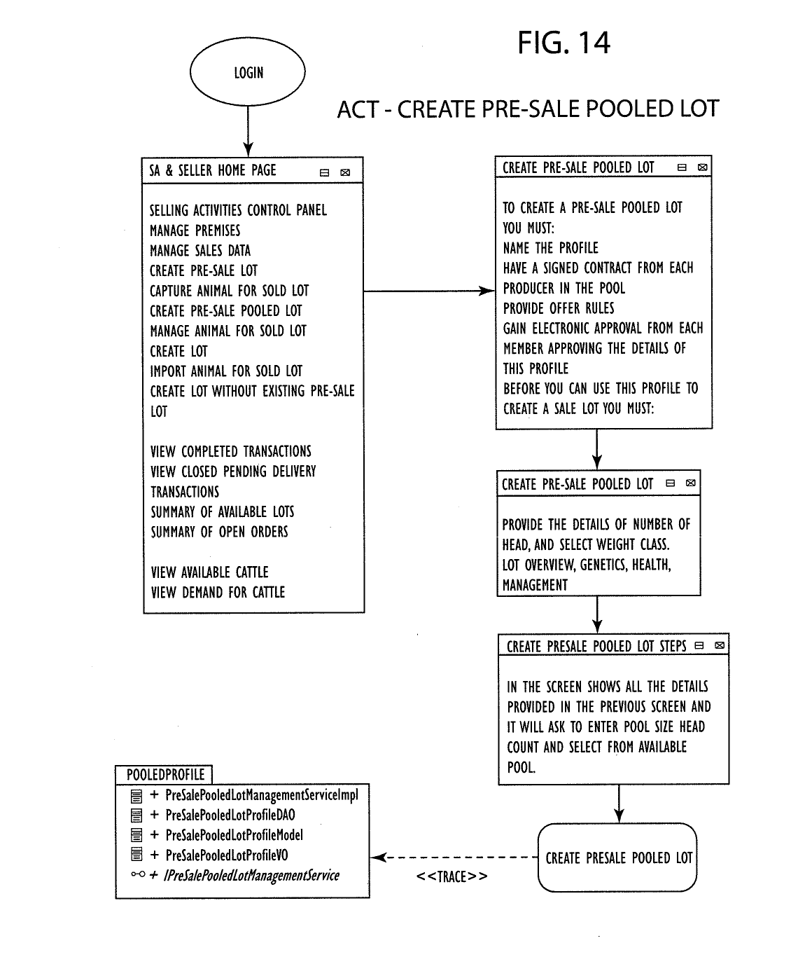

In addition, pre-sale lots can be formed (see e.g. FIGS. 12 and 13). Referring specifically to FIG. 13, the seller/seller agent inputs the inventory details such as quantity, class, weight, genetics, health, management, and name the profile created for the inventory. Then after submitting the characteristics, the seller will be prompted to select yes or no to allow pooling. If yes is selected then the system creates a pre-sale pooled lot (FIG. 14). If no is selected then the system creates a pre-sale lot.

The seller creates a name for the profile, signs a contract, and receives electronic approval from each member in the pool and by the administrator. Approval is the same as discussed above with regard to FIG. 13.

The producer accepts/rejects offer(s). After review, the producer selects each offer and selects accept, reject, or counter offer. Each buyer is notified of the decision. If the sale is still active, the buyer can rebid. Once a buyer accepts an offer, the auction is closed and all persons are notified. Buyers make payment and commission and fees are deducted. The money is then transferred to the producer's bank account. The transfer of funds allows a company to collect commission and insure seamless payment. The funds are received and held by the company till the cattle are received by the buyer.

Cattle are approved and become the property of the buyer as soon as they are loaded at the producers location on the shipping truck. Cattle are transported and received at buyers location. The shipping details will be specified in the order specifications at the beginning of the listing and may be negotiated during the bidding process.

The producer and buyer can write reviews of the transaction and it is posted to the buyer and producers account. The review process will assign values to the buyers and producers based on timely payment, and the accurate description of cattle.

Buy Side Activities

Referring now to the buyer side activities in more detail, a buyer will first register as a guest by inputting name, address, contact information, bank account information, all the traits of the cattle, and all the management practices of the ranch. The buyer is verified through the present system. The Administrator verifies references, bank account information, and line of credit for purchases. The Administrator calls references, and the personal banker for the buyer and verify the provided information. The references are reviewed by the Administrator and the buyer is issued an approval or denial for purchasing on the present system.

After information is verified, the Administrator creates an approval code for the buyer and it is noted in the account information for the buyer. The approval code is sent to the buyer through the present system. After this process is complete, the buyer may actively buy and list demand orders on the present system.

The Administrator then assigns a buyer agent to the buyer to profile his or her current and projected requirements to assist the buyer locate cattle. The system will utilize these profiles to continuously locate, rank and rate available inventory and facilitate a private treaty negotiation for each herd. A “buyer-centric”, portion of the present web-enabled system enables the buyers to manage their inventory pipeline and ensure the reliability of their supply chain. The information collected on the cattle is collected within the present system. This information will be used to show where value is added in cattle.

The buyer agent is assigned to the buyer to the counsel buyers on market trends current prices for all kinds of cattle. Buyers agents also find cattle that fit the order profiles created by that buyer. Buyer agents help create demand orders for listed and inventory not listed on the present system but known to the producer agents within their territory. Buyer agents can also purchase pooled cattle from several producers to meet the need of the buyers.

The buyer agent has the ability to combine cattle from several producers that have chosen the option to pool their cattle to make a truck load if he or she does not have enough cattle to make a truck load or fill an order from the buyer. This process of combining cattle from more than one producer is called pooling and allows the buyer to have more options in buying cattle and keeping their pipeline full.

The critical data contained in the buyers order profiles are collected within the present system. This information will be analyzed to show the demand, and buyers needed criteria for the wanted cattle.

The buyer then creates order profiles for the cattle that he or she wants to buy. The buyer inputs into the present system, all the traits wanted in the cattle, ship date, and/or the future date the cattle will be needed and any other information that is important to the buyer. The buyer can create and save several different order profiles of needed cattle. These order profiles are saved and can be accessed and or revised by the buyer and or the buyer agent. When the buyer wants to put an order in to the system he or she can select the pre-created order profile or make a new one and submit the order into the system.

Buyers can also buy unborn cattle (e.g. future sale) from a producer with an expected ship date in the future. This option is used to meet the future demand of that buyers. The information such as type of cattle, sell price of cattle, and needs of the buyers will be captured by the present system. This information will be used to predict supply needs, market trends, and help set prices for the cattle. Also this information will be used to created inventory with the producers that will be (future sale) pre-sale cattle.

The present system enables the buyer and buyer agent to search inventories currently on the system and the buyer agent will be in contact with several producer agents to see if there are cattle in his area but not listed in the system to meet the needs of the buyer.

A buyer can create a demand order by creating an order profile with all the traits of the cattle you want. An order is created when the profile(s) of the buyer's needs are entered into the system, named, and saved. Then the buyer/buyer agent can select the option to create order. This order is placed on the present system and registered and unregistered producers can view the profile of the wanted cattle. This allows producers to see the current and future need of buyers and produce and or sell current cattle that meets the buyer's needs. The demand order will be matched with the inventory currently listed on the system, future inventory that is not listed yet, and/or or product (cattle) that is not listed within the present system but is in the territory or geographical location of the producer agent. The producer agent knows the market that he works in and can ask non registered producers to meet the need of the buyer by selling their products (cattle). The information contained in demand orders will be collected and analyzed by the present system and agents and will produce data on future needs, market trends, and price changes.

The buyer/buyer agent can search current inventory, place a demand order and the buyer agent will be actively searching for cattle to meet the needs of the buyer. The demand order will be matched with the inventory currently listed on the present system, future inventory that is not listed yet, an or product (cattle) that is not within the present system but is in the territory of the producer agent. The cattle the buyer wants to bid on can be in different locations, owned by different producers, and in different quantities. After finding cattle that meets his or her needs the buyer can submit a Bid (make an offer) to the producer with the cattle. This offer is transmitted though our system and received in the producers account and at the home office. Once received the producer can select to accept, reject, or counter the offer. This bidding process creates an internet auction for the cattle that can be viewed by all registered users. This process in the present system allows the for the fluctuation and negotiation of the prices of cattle.

Offers made by buyers show up in the producer and producer agent's account(s) within the present system and the producer agent can place a telephone call or otherwise contact the producer to review the offer. Buyers can place several offers at one time and manage the offers within their account on the system. The order management within the present system works as a dash board to perform and manage all buying activities. The offers inputted in the present system allows the buyer agent to know the price ranges and bid to specified amount for the buyer. The buyer can also make one offer to several producers that has selected in their profile that they would pool the cattle. That one offer will be reviewed and if it meets the price range of the producers the offer will be accepted and cattle sold.

If the producer counter offers the buyer can accept, reject, cancel, and or counter offer. The buyer/buyer agents will see the multiple offers made in his or her account within the present system. The buyer/buyer agent can select an offer submitted on the present system to the producer and view or edit the offer and the details in the notes. If an offer is countered offered by a producer the buyer/buyer agent can counter offer and review the detail and notes contained in the offer. The buyer/buyer agent can choose an option to accept or reject the offer or to counter offer and bid more money or add special provisions within the notes. The counter offer will then be sent to the producer/producer agent by the present system's communication network. Then the counter offer will be reviewed again by the producer and he or she will have the option to send an accept/reject or counter offer back to the buyer. The process of accept/reject or counter offer will continue on the present system until all offers are rejected (canceled), or an offer is accepted. The buyer can place many offers to several of the producers that have Inventory listed on the system.

The offers submitted on the present system are captured and tracked by the system and the agents. This will help regulate the prices for other cattle of similar types regardless of location. This data will be used to create a national exchange system or ticker tape for reference of current minute by minute prices of cattle.

When producer accepts the offer, the auction is closed. The price and type of cattle will be captured in the system and used for future market research and analyzed to know what traits add value to the cattle. A buyer makes payment for cattle and commission and fees are deducted. Then the money is transferred to the producer's bank account. The transfer of funds allows company to collect commission and insure seamless payment.

Cattle never leave the producers location until the cattle are sold. This part of the present system saves the producer transportation cost, stress on the cattle, health problems are avoided, and the weight of the cattle is preserved. Cattle are considered approved by buyer and become the property of the buyer as soon as they are loaded at the producers location on the shipping truck. Cattle are transported and received at buyers location. The shipping will be specified in the order specifications. The shipping instructions will be reviewed during the offer/acceptance process as this may effect the winning bid.

The present method and system is described in further detail with required to the following example.

### Example

A the producer may elect to accept a lower offer if the producer is allowed to transport the cattle. The transport charges that the buyers pays for shipping will be paid to the producer to transport the cattle themselves.

Cattle are approved and transported as per the buyers specifications. The cattle can be received anywhere the buyer chooses: headquarters, leased property, feedlot, slaughter house, or any other place specified by the buyer.

The buyer and producer then write review of the transaction and it is posted to the buyer and producers account.

The review process will assign values to the buyers and producers based on timely payment, and the accurate description of cattle.

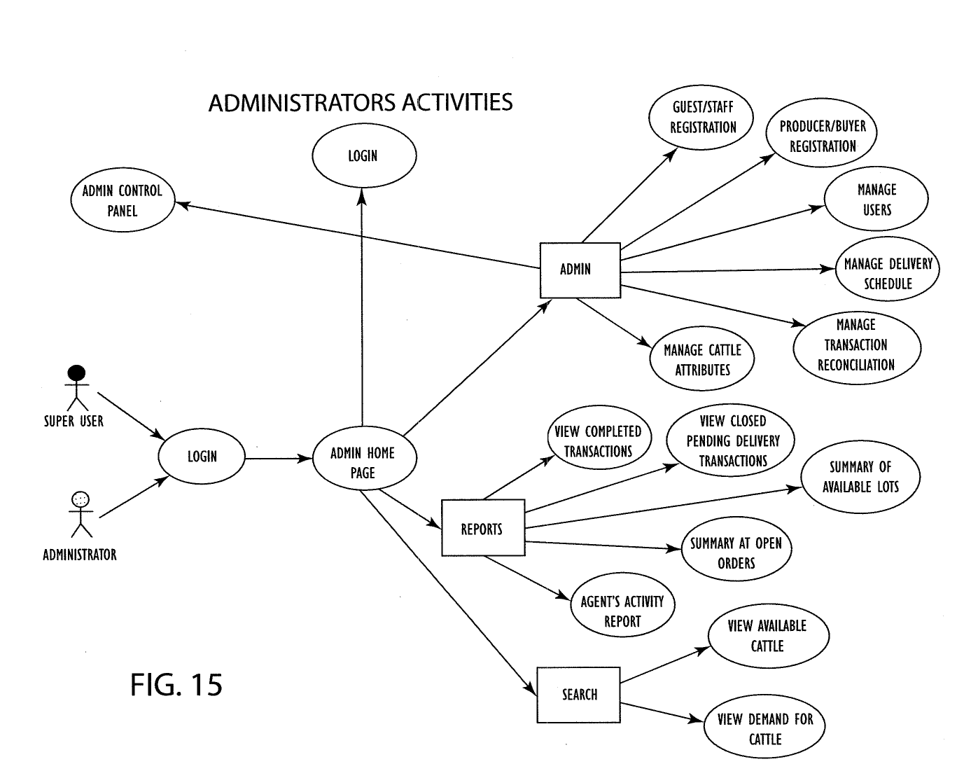

Referring now to FIG. 15, the diagram illustrates a summary of activities, reports and search capabilities of the administrator and/or super user.

It will now be clear to one of ordinary skill in the art that the present method and system provides features and advantages unique in the market of buying an selling goods and services.

Although the present system and method has been described above in relation to preferred embodiments thereof, it will be understood by those skilled in the art that variations and modifications can be effected in these preferred embodiments without departing from the scope and spirit of the invention.

1. A method for managing simultaneous multi-parameter negotiations for the purchase of products or services in an online private contract environment, the method comprising:
accepting a demand request from a buyer using a computer network in an online environment, said demand request consisting of a product or service with associated value-relevant product attributes and buyer quantity demand;
compiling an online accessible database consisting of the buyer demand request, with the associated value-relevant product attributes and buyer quantity demand; and
allowing multiple sellers to access the online database to negotiate simultaneously with the buyer on a private contract basis in order to satisfy the buyer's demand request.

2. The method of claim 1, further comprising finalizing a contract between the buyer and one or more seller thereby satisfying the buyer's request.

3. The method of claim 2, wherein the buyer's request is completely satisfied by forming at least two contracts between the buyer and at least two sellers, respectively.

4. The method of claim 1, wherein the product comprise livestock and the associated value-relevant product attributes are one or more selected from the group consisting of diet, weight, age, sex, ship date, delivery date and grade/quality.

5. The method of claim 1, further comprising producing a product with the associated buyer's requested value-relevant product attributes and quantity thereof, after viewing the buyer's request, by one or more sellers, to thereby meet the buyer's demand request.

6. The method of claim 1, further comprising accepting demand requests consisting of the product or service with associated value-relevant product attributes, from at least a second buyer using the computer network.

7. The method of claim 6, further comprising combining two or more demand requests from two or more buyers to form a pooled lot and said allowing multiple sellers to access the online database to negotiate simultaneously with the buyer on a private contract basis, comprises negotiating between the one or more sellers with one or more buyer's for the pooled lot.

8. The method of claim 6, wherein said allowing multiple sellers to access the online database to negotiate simultaneously with the buyer comprises a single seller negotiating with at least two buyers for the purchase of the seller's product.

9. The method of claim 6, further comprising conducting statistical analysis on the demand requests from at least two buyers to determine market trends.

10. The method of claim 1, wherein the value-relevant product attributes comprise data regarding a potential seller.

11. The method of claim 10, wherein the data regarding a potential seller is selected from the group consisting of years in business and financial stability.

12. The method of claim 1, further comprising pooling multiple sellers' respective inventories of the product or service to thereby form a pooled sellers' lot.

13. The method of claim 12, wherein the pooled sellers' lot satisfies the buyer's demand request.

14. The method of claim 12, further comprising purchasing the pooled sellers' lot by the buyer.

15. The method of claim 12, wherein the pooling multiple sellers comprises negotiating in the online environment between two or more sellers to pool their respective inventories of the product or service.

16. A method for managing simultaneous multi-parameter negotiations for the sale of a product or service in an online private contract environment, the method comprising:
permitting at least one seller to list a product or service to be sold, using a computer network in an online environment, said product and service comprising associated value-relevant product attributes and quantity of the product or service;
compiling an online accessible database consisting of the product or service with the associated value-relevant product attributes and quantity; and
allowing multiple buyers to access the online database to negotiate simultaneously with the at least one seller on a private contract basis in order to satisfy the multiple buyers' needs.

17. The method of claim 16, wherein allowing the multiple buyers to access the online database to negotiate comprises combining demand requests comprising the product or service and respective quantity of the product or service, from two or more buyers to form a pooled lot comprising the product or service and the associated value-relevant product attributes and a desired quantity of the product or service, and negotiating between the at least one seller and one or more of the multiple buyers for purchasing the pooled lot from the seller.

18. The method of claim 17, further comprising finalizing a contract between the one or more buyers and the at least one seller thereby completely satisfying the pooled lot.

19. The method of claim 16, wherein the at least one seller comprises multiple sellers, and said method further comprises pooling multiple sellers' respective inventories of the product or service to thereby form a pooled sellers' lot.

20. The method of claim 19, wherein the pooled sellers' lot satisfies at least one of the multiple buyers' needs.

21. The method of claim 20, further comprising purchasing the pooled sellers' lot by the at least one of the multiple buyers.

22. The method of claim 16, wherein pooling multiple sellers comprises negotiating in an online environment between two or more sellers to pool their respective inventories of the product or service.

23. The method of claim 16, further comprising finalizing a contract between the one or more buyers and the at least one seller thereby satisfying the multiple buyers' needs.

24. The method of claim 16, further comprising finalizing a contract between one buyer and the at least one seller thereby satisfying the buyer's need.

25. The method of claim 16, further comprising finalizing multiple contracts between a respective one of the buyers and the at least one seller thereby resulting in the sale of all of the product or service listed.

26. The method of claim 16, wherein permitting at least one seller to list a product or service to be sold, using a computer network in an online environment, comprises permitting multiple sellers to list their respective products or services with associated value-relevant product attributes and quantity of the products or services, and said allowing multiple buyers to access the online database to negotiate simultaneously with the multiple sellers on a private contract basis in order to satisfy the multiple buyers' needs.

27. The method of claim 16, wherein the product comprises livestock and the associated value-relevant product attributes are one or more selected from the group consisting of diet, weight, age, sex, ship date, delivery date and grade/quality.

28. The method of claim 16, wherein the value-relevant product attributes comprise data regarding the at least one seller.
